(19) United States
(12) Patent Application Publication
(10) Pub. No.: US 2011/0036554 A1
(43) Pub. Date: Feb. 17, 2011

(54) COOLING ARRANGEMENT, SERVER RACK AND METHOD FOR CONTROLLING A COOLING ARRANGEMENT

(75) Inventors: Gerold Scheidler, Bad Wunnenberg (DE); Bernhard Schräder, Delbruck (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: SINITEC VERTRIEBSGESELLSCHAFT MBH, Munchen (DE)

(21) Appl. No.: 12/628,319

(22) Filed: Dec. 1, 2009

(30) Foreign Application Priority Data
Aug. 14, 2009 (DE) 102009037567.8

(51) Int. Cl. G05D 23/00; F28D 15/00

(52) U.S. Cl. 165/281; 165/104.33

(57) ABSTRACT

The cooling arrangement for a server rack for accommodating a plurality of plug-in components includes a vertically running coolant air channel, having a plurality of air intake openings and a common exhaust air opening. Air intake openings can each be connected to an air outlet opening of a plug-in component, whereby the corresponding air intake opening is assigned to plug-in component. Air intake openings each have a throttle element for varying their air passage cross section.

### RELATED APPLICATION

This application claims priority of German Patent Application. No. 102009037567.8, filed Aug. 14, 2009, herein incorporated by reference.

### TECHNICAL FIELD

This disclosure relates to =a cooling arrangement for a server rack for accommodating a plurality of plug-in components. The disclosure further relates to a server rack with such a cooling arrangement and a method for controlling a cooling arrangement for a server rack.

### BACKGROUND

Server racks, also called server or computer cabinets, serve to accommodate a plurality of plug-in components, particularly servers. A standardized width of 19″ is often provided for the inserts. With respect to their height, the inserts are usually oriented to the likewise standardized height units (u=unit), where 1 u corresponds to 1.75″. To achieve a high packing density of servers, especially for providers of Web services, up to 40 servers or more with a height of 1 u can be provided.

The cooling of the servers is generally assured by ambient air, which is drawn on the front side of the server and led inside the server over components to be cooled, e.g., one or more CPUs (central processing units), and emitted on the rear side of the server. To produce an appropriate coolant air stream in the server, ventilators are integrated into the servers or positioned in modules directly behind the servers. Typically, a plurality of ventilators arranged side by side is provided for each server, but due to the low overall height of the servers, they can only have a very small diameter for their rotor blades as well. To produce a sufficient coolant air stream through the server despite their small rotor diameters, these ventilators must be operated at high rotational speed. A high rotational speed is generally accompanied by an inefficient operation of the fans, however, so that with the above-mentioned 40 servers per server rack, roughly 3 kW of electrical energy are necessary for operating the fans of a server rack. It is alternatively possible to provide fan modules that are arranged behind the servers and extend in height over several height units, i.e., over several servers. Such fan modules can be operated more efficiently because of the larger rotor diameter of their fans, but an individual regulation of the coolant air for each server is not possible, since each fan module supplies several servers.

It could therefore be helpful to provide a cooling arrangement for a server rack that enables cooling that is effective and can be regulated individually for each server. It could also be helpful to provide a server rack with a corresponding; cooling arrangement, and a method for controlling such a cooling arrangement.

### SUMMARY

We provide a cooling apparatus for a server rack that accommodates a plurality of plug-in components including a substantially vertically oriented coolant air channel having a plurality of air intake openings, each of which is sized and shaped to connect to an air outlet opening of a plug-in component, whereby the corresponding air intake opening is assigned to the plug-in component, and a common exhaust air opening, wherein air intake openings each have a throttle element that varies their air passage cross section.

We also provide a server rack that accommodates insertable electronic devices including the cooling apparatus.

We further provide a method for controlling a cooling arrangement in a server rack with a plurality of plug-in components including drawing coolant air from an exhaust opening in a cooling arrangement having a coolant air channel with a plurality of air intake openings each connected to an air outlet opening of one of the plug-in components, and a common exhaust air opening connected to at least one ventilator in such a manner that the ventilator draws coolant air from the exhaust air opening during operation, determining an air pressure in the coolant air channel with at least one pressure sensor, determining the ambient air pressure with another pressure sensor, actuating each of the throttle elements with an actuator as a function of the operating parameters of the plug-in component connected to the corresponding air intake opening, varying air passage cross section of each of the air intake openings with a throttle element, and controlling the at least one ventilator with respect to its rotational speed as a function of the measured air pressure and the ambient air pressure in the coolant air channel.

### BRIEF DESCRIPTION OF THE DRAWINGS

The apparatus will be described in detail below with reference to representative examples with the aid of four figures.

Therein:

FIG. 1 shows a schematic representation of a server rack with a plurality of plug-in components and a cooling arrangement;

FIG. 2 shows a perspective representation of a part of a coolant air channel of a cooling arrangement;

FIG. 3 shows a schematic sectional representation of a part of a coolant air channel of a cooling arrangement; and

FIGS. 4A and 4B show arrangements for performing the method for controlling a cooling arrangement.

### DETAILED DESCRIPTION

It will be appreciated that the following description is intended to refer to specific examples of structure selected for illustration in the drawings and is not intended to define or limit the disclosure, other than in the appended claims.

We provide a cooling arrangement for a server rack for accommodating a plurality of plug-in components. The cooling system comprises a vertically running coolant air channel that has a plurality of air intake openings, each of which can be connected to an air outlet opening of a plug-in component; whereby the corresponding air intake opening is assigned to the plug-in component, and which coolant air channel has a common exhaust air opening, wherein the air intake openings each have a throttle element for varying their air passage cross section.

In this way, a coolant air stream can be provided jointly for several plug-in components, with the throttle elements enabling an individual regulation of the amount of coolant air for each component. The throttle elements may be constructed as ventilation slides with a fixed slot plate and movable slot plate. In an equally advantageous configuration, the throttle elements may be constructed as ventilation flaps.

An actuator for adjusting the throttle element may be provided for each throttle element. A control unit for driving the actuator is particularly advantageously provided for each actuator, and the control unit may be electrically connected for control purposes to the plug-in component to which the corresponding air intake opening is assigned. In this manner, each of the plug-in components can adjust its coolant air quantity individually.

A ventilator unit may be connected to the common exhaust air opening of the coolant air channel for drawing air out of the coolant air channel. In that way, one or more effective ventilators with a large radial diameter can be used.

A rotational speed control unit is particularly advantageously provided with a control loop with which a rotational speed of at least one ventilator of the ventilator unit may be controlled as a function of a measured air pressure in the coolant air channel. Particularly advantageously, at least one pressure sensor for measuring an air pressure in the coolant air channel may be provided. In this manner, a constant negative pressure can be maintained in the coolant air channel. Consequently, a given setting of a throttle element leads to a defined coolant air stream through a plug-in component, which makes the setting of the throttle element easier to control or regulate.

A cooling arrangement for a server rack for accommodating a plurality of plug-in components is provided. We also provide a method for controlling a cooling arrangement in a server rack with a plurality of plug-in components, wherein the cooling arrangement has a coolant air channel with a plurality of air intake openings, each connected to an air outlet opening of one of the plug-in components, and has a common exhaust air opening. The common exhaust air opening may be connected to the at least one ventilator in such a manner that in operation the ventilator draws coolant air out of the exhaust air opening. Each of the air intake openings may have a throttle element for varying its air passage cross section, and at least one pressure sensor may be provided for determining an air pressure in the coolant air channel, and another pressure sensor may be provided for determining the ambient air pressure. In the method, each of the throttle elements may be actuated by an actuator as a function of the operating parameters of the plug-in component connected to the corresponding air intake opening. The at least one ventilator may additionally be controlled with respect to its rotational speed as a function of the measured air pressure in the coolant air channel as well as the ambient air pressure.

The advantages of the server rack and the method correspond to those of the cooling arrangement.

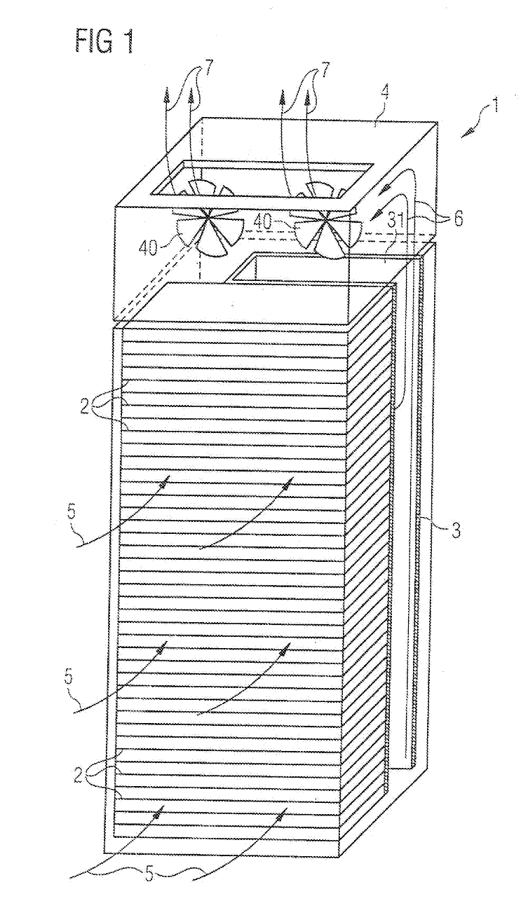

In a perspective schematic representation, FIG. 1 shows a: server rack 1, into which a plurality of plug-in components 2, 40 in this case, are inserted. A vertical coolant air channel 3 runs in the area behind the plug-in components; its exhaust air opening 31 opens into a ventilator unit 4 placed above the plug-in components 2 and the coolant air channel 3. Ambient air 5 enters the plug-in components 2 through the front side. It is first drawn as coolant air 6 through the plug-in components and subsequently through coolant air channel 3 into ventilator unit 4. For this purpose, ventilator unit 4 is equipped with two ventilators 40. Coolant air 6 leaves the ventilator unit 4 as exhaust air 7.

In the example shown in FIG. 1, server rack 1 is equipped, for example, with 40 servers as plug-in components 2. For the sake of simplicity, these will be referred to below as servers 2. In addition to servers, however, the insertion of network components such as routers or switches, or of storage components such as NAS modules (network attached storage) as plug-in components 2 is equally possible. A combination of different plug-in components inside one server rack 1 is likewise conceivable.

The servers 2 in the example have no ventilators for generating air stream 6 integrated into themselves or arranged behind the server rack in modules. Instead, one common ventilator unit 4 is provided, the ventilators 40 of which draw coolant air 6 out of coolant air channel 3 and emit it as exhaust air 7. The resultant negative pressure in the coolant air channel causes ambient air 5 to enter servers 2 through corresponding air inlet openings on the front side of servers 2, which is conducted as coolant air 6 in the interior of the servers over one or more components to be cooled, such as one or more central processing units (CPU). Coolant air 6 leaves servers 2 via air outlet openings on their rear side (not visible in FIG. 1), which are connected to corresponding air intake openings of vertically arranged coolant air channel 3.

Not shown in the figure are additional channels or tubes via which exhaust air 7 is conveyed, for example, to supply it to the heat recovery system. It is alternatively possible to conduct the exhaust air 7 without further measures out of the building in which server rack 1 is operated.

In the example of FIG. 1, two ventilators 40 arranged in a vertical partition wall (not visible in FIG. 1) inside the ventilator unit 4 are provided to build up a negative pressure at the common air outlet opening 31 and thus inside coolant air channel 3, by which means coolant air 6 is drawn through servers 2. In place of the two illustrated ventilators 40 arranged side by side and operating simultaneously, it can alternatively be provided that only one of two available ventilators 40 is used in normal operation, the other being planned as a redundant replacement in case of failure of the other ventilator. In such a configuration, arrangements such as closure caps are additionally provided to prevent a flow of coolant air back through a non-operated ventilator. It is alternatively possible not to position the ventilator unit directly on server rack 1, but instead to connect exhaust air opening 31 directly to an exhaust air system in which remotely arranged ventilators, optionally used centrally for several server racks, produce a negative pressure.

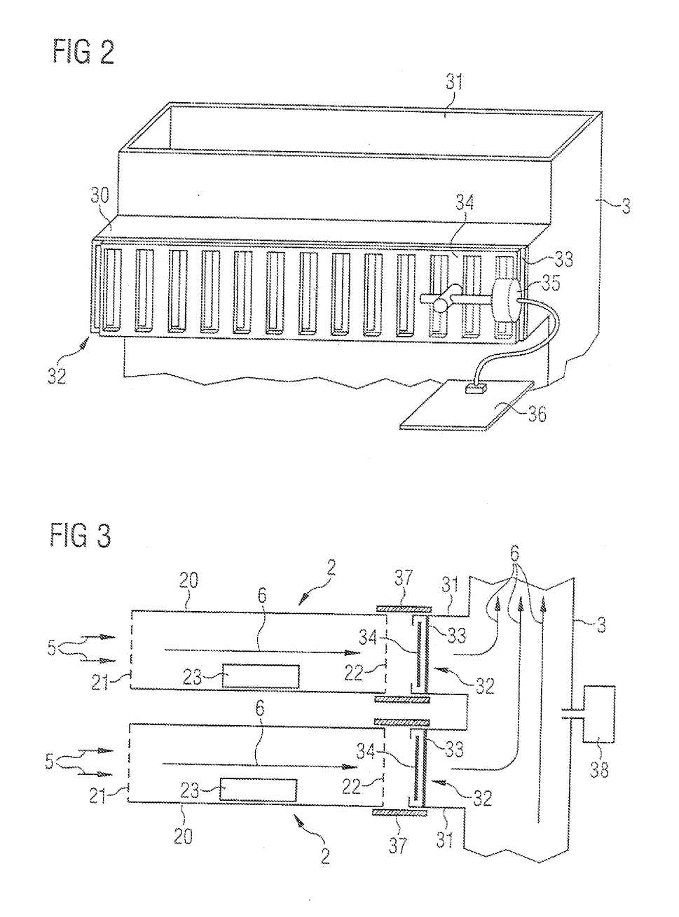

To regulate the amount of coolant air 6 that flows through a server 2, each air intake opening of coolant air channel 3 that is connected to the corresponding air outlet opening of a server 2 is equipped with a throttle element that makes it possible to variably reduce the respective air passage cross section of the air intake opening. These throttle elements (not visible in FIG. 1) will be described in detail with reference to FIGS. 2 and 3.

A part of a coolant air channel 3 is reproduced in FIG. 2 in a perspective schematic drawing. Coolant air channel 3 has a plurality of air intake openings 30, of which only the uppermost one is represented in FIG. 2. Additional, analogously constructed air intake openings 30 follow in the downward direction. At the upper end of coolant air channel 3, it issues into the common exhaust air opening 31. A corresponding lower end of coolant air channel 3 is closed off. A throttle element 32 is arranged in front of air intake opening 30. It comprises a stationary slot plate 33 as well as a slot plate 34 that is laterally movable with respect to this stationary slot plate 33. Both slot plates 33, 34 have ventilation slots separated by webs. Throttle element 32 is additionally equipped with an actuator 35 that allows a displacement of movable slot plate 34. Actuator 35 is electrically connected to control, unit 36.

A cutout of the front side of air channel 3 facing the servers during normal operation is visible in FIG. 2. With the server inserted, the air intake opening 30 that is shown is connected to a correspondingly large air outlet opening of the server. In the present case, air intake opening 30 is drawn projecting slightly forward as a connection piece. An air intake opening arranged flush on the front side of coolant air channel 3 is equally possible, however. The width of coolant channel 3 can be designed over the entire width of server 2, or over only a part of server 2. The width of air intake openings 30 can likewise extend over the entire width of server 2, or only over part of its width, wherein the air intake opening 30 can also be constructed narrower than coolant air channel 3. With respect to its height as well, it is possible to construct air intake openings 30 over the entire height of server 2, or only over a part of its height.

Typically, the electrical terminals of the servers 2 for power supply and data exchange are also arranged on the rear side of server 2 facing away from coolant air channel 3. They are positioned alongside and/or above or below the air intake openings 30, depending on the dimensioning and arrangement of air intake openings 30. Particularly if coolant air channel 3 is constructed wider than air outlet openings 30, a projecting connection piece design of air outlet openings 30 is advantageous for reasons of space.

With stationary slot plate 33 and movable slot plate 34, throttle element 32 has two plates furnished with openings of the same type. If the openings of the two plates are made to coincide exactly with one another by movement of movable slot plate 34, throttle element 32 has the largest air passage cross section. If, on the other hand, the slots of movable slot plate 34 are brought to coincide with the webs of stationary slot plate 33, throttle element 32 has the smallest air passage cross section. With an appropriate design of the slots in relation to the webs remaining between them, air intake opening 30 can be essentially completely closed off by throttle element 32. Alternatively to the design of throttle element 32 in the form of a ventilation slide, throttle element 32 can also be constructed as a ventilation flap (throttle flap) or with adjustable shutter blades.

For the electrically actuated adjustment of throttle element 32, an actuator 35, realized here for the sake of example with a stepper motor and a threaded rod transmission, is provided in the present case. Optionally, limit switches for the positioning movement, in the form of mechanical switches or of optical or inductive switching elements, for example, can be arranged on movable slot plate 34 (not shown in FIG. 2). The control of actuator 35 and, optionally, the detection and evaluation of the limit switches are handled by control unit 36.

A cross section through a section of coolant air channel 3 and server 2 upstream is presented in FIG. 3. The section shown is selected here from a central vertical area of server rack 1. Accordingly, additional servers 2 adjoin it above and below. The servers 2 each have a housing 20 with an air inlet opening 21 on the front side and an air outlet opening 22 on the rear side. Inside server 2 there is a mainboard 23 on which the components to be cooled, e.g., one or more CPUs, are mounted. The servers 2 are each positioned in front of an air intake opening 30 of coolant air channel 3, wherein a surrounding seal 37 connects server 2 to air intake opening 30. A throttle element 32, again comprising a stationary slot plate 33 and a movable slot plate 34, is arranged in the respective air intake opening 30. The actuator and the control unit shown in FIG. 2 are not visible in this representation. A pressure sensor 38 is arranged in the side wall of coolant air channel 3.

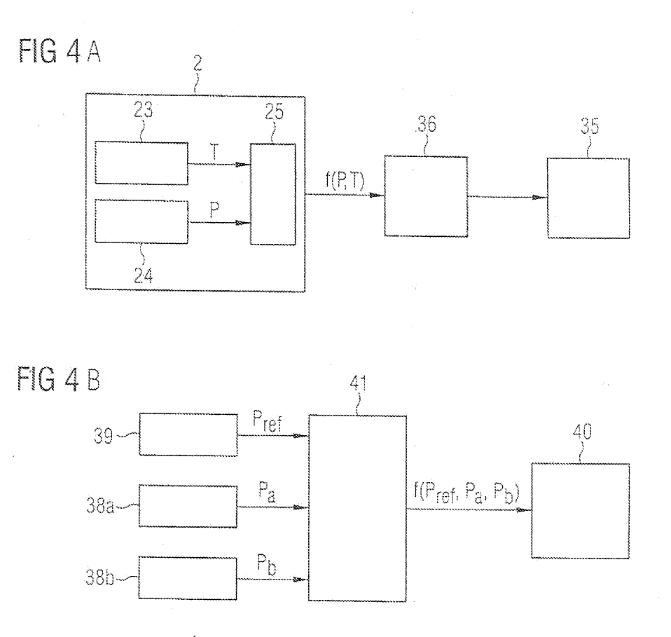

In the operation of the cooling arrangement, a negative pressure is adjusted in coolant air channel 3 by the ventilators 40 of the ventilator unit 4 (not visible in FIG. 3) that is connected at the upper end of coolant air channel 3 to common exhaust air opening 31. This negative pressure can be measured via pressure sensor 38 to regulate the ventilators 40. A corresponding arrangement and a method for it will be explained in detail in connection with FIG. 4.

In case of a completely or partially opened throttle element 32, the negative pressure in coolant air channel 3 leads to the intake of ambient air 5 through the respective air inlet openings 21 of server 2, whereby coolant air 6 for cooling is conducted over components of server 2 and is drawn through air intake opening 30 into coolant air channel 3 and to ventilator unit 4. For a given negative pressure in coolant air channel 3, which results from the difference between the pressure in, coolant air channel 3 and the ambient air pressure, the coolant air 6 flowing through a respective server 2 can be by adjustment of the throttle element and thus the variation of the air passage cross section of air intake opening 30. The maximum amount of coolant air 6 flowing through a server 2 is determined by the flow resistance in server 2, the flow resistance of air intake opening 30 (with a maximally opened throttle element 32) and the negative pressure in coolant air channel 3. With an appropriate design of throttle element 32, the coolant air stream 6 through an air intake opening 30 can be completely cut off—almost completely, that is, if one takes into account possible leaks of a closed throttle element 32. Such a setting makes sense, for example, with server 2 shut off or if the installation shaft to which air intake opening 30 is assigned is not populated in server rack 1.

The cooling arrangement represented in FIGS. 1-3 thus makes it possible to cool the plug-in components with the aid of one or a few centrally positioned ventilators with large rotor diameters, positioned on or remote from server rack 1. The throttle element 32 provided at each air intake opening 30 for an installed component 2 allows a regulation of the coolant air stream individually matched to the cooling need of each plug-in component 2.

A method for controlling such a cooling arrangement will be discussed in detail with reference to FIG. 4.

FIG. 4A shows an arrangement for controlling a throttle element 32. A mainboard 23 and a power, supply unit 24 are shown for a server 2 that is to be cooled. The parameters relevant to the cooling are, e.g., the temperature T of the drawn-in coolant air as well as the power requirement P of server 2, which represents a measure of the heat generation in server 2. The temperature of the drawn-in coolant air is measured in this example at a suitable point on mainboard 23. The power requirement of server 2 is determined in the power supply unit 24. Both parameters are provided to a system management board 25. Based on a predetermined functional connection, system management board 25 determines a parameter f (P, T) and relays it to control unit 36 located outside of server 2. This unit controls actuator 35 to adjust throttle element 32 corresponding to the currently acquired power requirement. Alternatively or additionally to the parameters P and T used here, additional relevant operating parameters from which the cooling requirement of a server can be deduced, such as the temperature of a CPU in server 2, can be used to control throttle element 32. Alternatively to the configuration shown, in which the internal server system management board 25, usually already present, is set up for controlling throttle element 32, a controller specially provided inside a server for this purpose can be used.

As represented in FIG. 4A, each of the servers 2 arranged in server rack 1 controls the associated throttle element 32. In the example shown, the adjustment of throttle element 32 is based on the temperature T of the coolant air drawn in and the current power demand P of a server 2. Alternatively to such control, throttle element 32 can also be adjusted via a control loop, with the temperature of a component to be regulated as the regulation parameter, for example. A regulation taking controlling parameters into account is also conceivable (presumptive regulation or regulation with feedforward control).

The rotational speed of the ventilators 40 in ventilator unit 4 is initially controlled independently of the driving of the individual throttle elements 32, as illustrated in FIG. 4B. For this purpose, the ambient air pressure p_{ref} acquired by an additional pressure sensor 39, as well as two pressures pₐ and p_{b} inside coolant air channel 3 acquired by pressure sensors 38a and 38b, are transmitted to a rotational speed control unit 41. The two pressure sensors 38a and 38b are arranged at different vertical positions inside coolant air channel 3, for example, at the upper and the lower ends. Rotational speed control unit 41 determines the required rotational speed of ventilators 40 as a function of the acquired pressures p_{ref}, Pₐ and P_{b} in such a manner that the pressure difference between a mean pressure in coolant air channel 3 and the ambient air pressure takes on a constant value. The pressure reference Δp=f(p_{ref}, pₐ, p_{b}) is determined here as, e.g., p_{ref}−(pₐ+p_{b}/2). In addition to this equilibrium accounting for the pressures pₐ and p_{b} in the averaging, a different weighting, adapted to the pressure profile arising in coolant air channel 3, is equally conceivable. Alternatively to the regulation arrangement shown in FIG. 4B, in which there is a pressure measurement at two different points in coolant air channel 3, a central pressure measurement in coolant air channel 3, for example, approximately roughly in the center vertically, can also be undertaken. The rotational speed is then regulated to a constant predetermined pressure difference between, ambient air pressure and the pressure inside coolant air channel 3, measured by the one pressure sensor 38.

It is advantageous for the control or regulation as represented that the throttle elements for each individual server be controlled independently of one another and independently of the control loop for the rotational speed of ventilator 40 of the cooling arrangement. Such an independent configuration reduces the occurrence of undesired oscillations in the control or regulation behavior of the different elements. There can be an additional decoupling of the elements by choosing suitable time constants and damping constants in the regulation.

As an alternative to the illustrated example of FIG. 4, it is possible to pass the acquired parameters relevant to the cooling, such as the power output of power supply module 24 and the temperature of the intake coolant air, as well as additional server-specific parameters from system management board 25; via a corresponding network to a central acquisition point, e.g., an administration computer. Such a central acquisition of operating parameters for server 2 is already common for monitoring them. The operating parameters thus present centrally for all servers 2 can be evaluated at a central point and converted into corresponding instructions to control units 36 for controlling actuators 35. These units would then be connected to the central acquisition device and would be correspondingly controlled by it. This connection can likewise take place via a network—again, the system administration network, if desired. The central acquisition and evaluation of the operating parameters would offer the additional advantage of monitoring the controlling, of the ventilators, in addition to the illustrated pressure difference regulation. For example, the pressure difference Δp specified to the control loop and to be achieved by it could be adjusted in the direction of larger values in case—due to a high utilization rate—one or more of the servers 2 are not being sufficiently cooled despite a completely open throttle element 32. It is additionally even possible to forgo a pressure difference measurement altogether and to set up a control of ventilators 40 from a suitable functional dependence of the detected and centrally acquired operating parameters P and T, as well as the position of throttle elements 32 that is transmitted to control unit 36.

### LIST OF REFERENCE CHARACTERS

1 Server rack
2 Plug-in component
3 Coolant air channel
4 Ventilator unit
5 Incoming air
6 Coolant air stream
7 Exhaust air
20 Housing
21 Air inlet opening
22 Air outlet opening
23 Mainboard
24 Power supply module
25 System management board
30 Air intake opening
31 Exhaust air opening
32 Throttle element
33 Stationary slot plate
34 Movable slot plate
35 Actuator
36 Controller
37 Seal
38a,b Pressure sensor
39 Additional sensor
40 Ventilators

Although the apparatus and methods have been described in connection with specific forms thereof, it will be appreciated that a wide variety of equivalents may be substituted for the specified elements described herein without departing from the spirit and scope of this disclosure as described in the appended claims.

1. A cooling apparatus for a server rack that accommodates a plurality of plug-in components comprising a substantially vertically oriented coolant air channel having:
a plurality of air intake openings, each of which is sized and shaped to connect to an air outlet opening of a plug-in component, whereby the corresponding air intake opening is assigned to the plug-in component, and
a common exhaust air opening,
wherein air intake openings each have a throttle element that varies their air passage cross section.

2. The cooling apparatus according to claim 1, in which the throttle elements are constructed as ventilation slides with a fixed slot plate and a movable slot plate.

3. The cooling apparatus according to claim 1, in which the throttle elements are constructed as ventilation flaps.

4. The cooling apparatus according to claim 2, in which the throttle elements completely close off air intake openings.

5. The cooling apparatus according to claim 2, further comprising an actuator for adjusting throttle element for each throttle element.

6. The cooling apparatus according to claim 5, further comprising a control unit for a driving actuator for each actuator.

7. The cooling apparatus according to claim 6, in which the control unit connected to actuator of throttle element of one of the air intake openings is electrically connected to control the latter to the plug-in component to which the corresponding air intake opening is assigned.

8. The cooling apparatus according to claim 1, further comprising a ventilator unit connected to common exhaust air opening of coolant air channel to draw air from coolant air channel.

9. The cooling apparatus according to claim 8, further comprising a rotational speed control unit with a control loop by which means a rotational speed of at least one ventilator of ventilator unit is controlled as a function of a measured air pressure in coolant air channel.

10. The cooling apparatus according to claim 8, further comprising at least one pressure sensor to measure an air pressure in coolant air channel.

11. The cooling apparatus according to claim 9, further comprising an additional pressure sensor to measure ambient air pressure, wherein rotational speed control unit controls rotational speed of the at least: one ventilator as a function of a pressure difference between measured air pressure in coolant air channel and ambient air pressure.

12. A server rack that accommodates insertable electronic devices comprising the apparatus according to claim 1.

13. A method for controlling a cooling arrangement in a server rack with a plurality of plug-in components, comprising:
drawing coolant air from an exhaust opening in a cooling arrangement having a coolant air channel with a plurality of air intake openings, each connected to an air outlet opening of one of the plug-in components, and a common exhaust air opening connected to at least one ventilator in such a manner that the ventilator draws coolant air from the exhaust air opening during operation,
determining an air pressure in the coolant air channel with at least one pressure sensor;
determining the ambient air pressure with another pressure sensor;
actuating each of the throttle elements with an actuator as a function of the operating parameters of the plug-in component connected to the corresponding air intake opening; and
controlling the at least one ventilator with respect to its rotational speed as a function of the measured air pressure and the ambient air pressure in the coolant air channel.

14. The method according to claim 13, further comprising actuating the throttle elements as a function of the temperature of a CPU of plug-in component.

15. The method according to claim 14, further comprising actuating power supply modules and throttle elements of the plug-in components as a function of power output by one of the power supply modules.
